(19) United States
(12) Patent Application Publication
(10) Pub. No.: US 2024/0399182 A1
(43) Pub. Date: Dec. 5, 2024

(54) SUSPENSION AND CONTROL HEAD APPARATUS FOR AERIAL FIREFIGHTING BUCKETS

(71) Applicant: SEI MANUFACTURING INC., Delta (CA)

(72) Inventor: Donald Brian ARNEY, Delta (CA)

(73) Assignee: SEI MANUFACTURING INC., Delta, BC (CA)

(21) Appl. No.: 18/676,095

(22) Filed: May 28, 2024

Related U.S. Application Data
(60) Provisional application No. 63/469,514, filed on May 29, 2023.

(51) Int. Cl. A62C 3/02; B64D 1/16

(52) U.S. Cl. CPC A62C 3/0235; B64D 1/16

(57) ABSTRACT

A suspension and control head apparatus includes: a cable attachment member; a housing having an exterior face; an electronic head control system; a drive pulley system mounted to the exterior face, the drive pulley system includes: a valve control line with a first end and a second end; an end piece on the first end; a drive pulley with a first face and a second face defining a channel there between running along the circumference of the drive pulley; a groove on the first face of the drive pulley configured to fit the end piece; and a driver system; wherein the valve control line is removably inserted into the groove and the channel and the valve control line is retractable and extendable from the drive pulley. The location and features of the drive pulley system allows for ease of access for maintenance and replacement of the valve control line.

### TECHNICAL FIELD

The invention relates to a suspension and control head apparatus for aerial firefighting buckets.

### BACKGROUND

Aerial firefighting buckets, particularly those for carrying by helicopter or other hover capable aircraft, are well known. Some examples of aerial firefighting buckets in the prior art are disclosed in U.S. Pat. Nos. 4,474,245; 4,576,237; 5,560,429; 7,708,082; and 8,453,753. These patents disclose helicopter carried firefighting buckets that, at their simplest, comprise a rigid or flexible reservoir for holding a volume of water, a sling to suspend the reservoir from a helicopter, a valve, and an actuator which is controlled from inside the helicopter to operate the valve to release the water from the reservoir over the fire. Prior art aerial firefighting bucket systems generally include a bucket for containing a volume of fluid. The bucket includes a bottom interior surface having a valve thereon for controllably releasing a stream of the fluid over a fire, for example. The bucket is suspended from a control head by bucket support cables and the control head is connected to the cargo hook of a helicopter. A control cable runs between the helicopter and the control head to transmit instructions from an operator to the control head. The control cable may be an electrical cable, a hydraulic hose, or a pneumatic hose, for example. An actuator cable may be connected between the control head and the valve to enable the control head to open and close the valve in response to operator commands. Various actuator mechanisms of the control head are known in the prior art, including some described in the patents mentioned above herein.

A problem with some control heads of the prior art is that it can be difficult or cumbersome to repair or replace parts contained within the control head. For example, the actuator cable is prone to damage and needs constant replacement, which often necessitates significant downtime for repair. Also, the height of some existing control heads can cause damage to the helicopter if its not correctly set down when landing. As well, the closeness of the suspension lines on existing heads means that the suspension lines are more likely to allow the bucket to spin, wrapping the suspension lines around the trip line, which can interfere with the valve dumping.

### SUMMARY

In one aspect, the disclosure describes a suspension and control head apparatus for an aerial firefighting bucket, which includes: a cable attachment member; a housing connected to the cable attachment member, the housing having an exterior face and an interior face; an electronic head control system contained in the housing, the electronic head control system for transmitting signals; a drive pulley system mounted to the exterior face of the housing, the drive pulley system includes: a valve control line with a first end and a second end; an end piece on the first end; a drive pulley with a first face and a second face defining a channel there between running along the circumference of the drive pulley; a groove on the first face of the drive pulley configured to fit the end piece of the valve control line; and a driver system connected to the electronic head control system and the drive pulley system, the driver system for driving the drive pulley system; wherein the valve control line is removably inserted into the groove and the channel and the valve control line is retractable and extendable from the drive pulley. In some embodiments, the apparatus further includes a pulley cover removably mounted to the first face of the drive pulley.

In some embodiments, the apparatus further includes a pulley guard extending from the exterior face of the housing and configured to engage with the channel of the drive pulley, the pulley guard cooperating with the channel to maintain the valve control line within the channel.

In some embodiments, the apparatus further includes a pulley shield removably mounted to the exterior face of the housing and configured to shield the drive pulley system.

In some embodiments, the driver system of the apparatus further includes: a motor; a drive shaft connected to the motor, the motor driving the drive shaft; a cam surface connected to the drive shaft; and limit switches disposed in a position relative to the cam surface to enable the cam surface to actuate the limit switches; wherein the cam surface is configured to actuate the limit switches to limit the extent of rotation of the drive pulley.

In some embodiments, the end piece of the apparatus is an enlarged cable end stop.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a front view of an aerial fire-fighting bucket system with an embodiment of a suspension and control head apparatus;

FIG. 2 is a perspective front view of an embodiment of a suspension and control head apparatus in accordance with the present invention;

FIG. 3 is a perspective front view of the embodiment of a suspension and control head apparatus of FIG. 2 with the pulley shield removed;

FIG. 4 is a perspective front view of the embodiment of a suspension and control head apparatus of FIG. 2 with the pulley shield and pulley cover removed;

FIG. 5 is a perspective bottom view of the embodiment of a suspension and control head apparatus of FIG. 4;

FIG. 6 is a perspective internal back view of the embodiment of a suspension and control head apparatus of FIG. 2;

FIG. 7 is a perspective internal side view of the embodiment of a suspension and control head apparatus of FIG. 2;

FIG. 8 is a bottom cross-section view of the embodiment of a suspension and control head apparatus of FIG. 2; and

FIG. 9 is a close-up cross-section view of the embodiment of a suspension and control head apparatus of FIG. 8.

### DETAILED DESCRIPTION

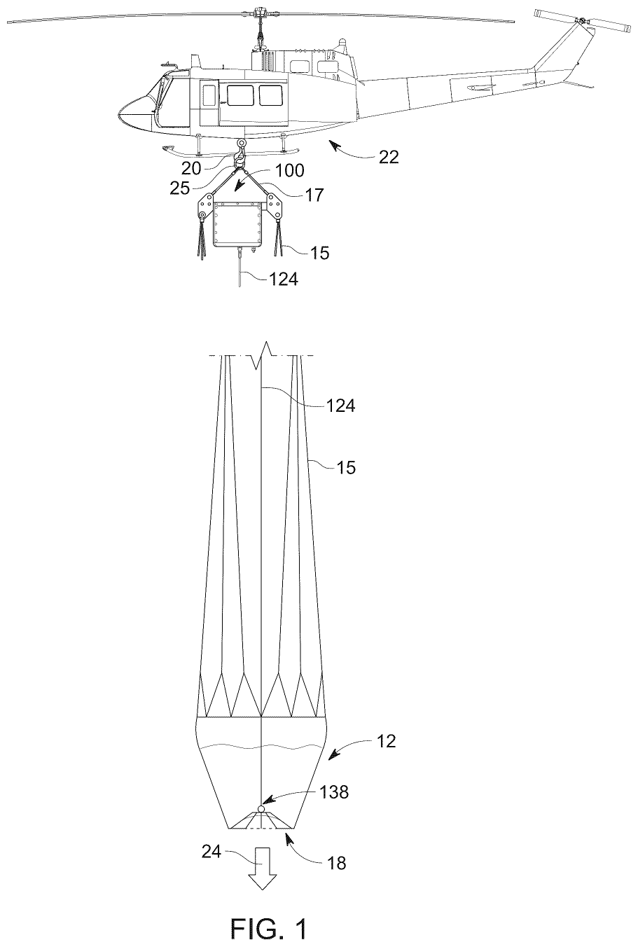

Referring to FIG. 1, there is shown an aerial fire-fighting bucket system having a suspension and control head apparatus 100, or simply referred to herein as a control head 100, according to one aspect of the invention. The aerial firefighting bucket system includes a bucket 12 for containing a volume of fluid. Bucket 12 includes a bottom interior surface having a valve 18 thereon for controllably releasing a stream 24 of the fluid over a fire, for example. Bucket 12 is suspended from control head 100 by bucket support cables 15 and control head 100 is suspended from cargo hook 20 of helicopter 22 by cargo ring 25 that is connected to suspension lines such as control head support cables 17. Control head 100 includes a valve control line 124 that is connected to valve 18 to enable control head 100 to open and close valve 18 in response to operator commands. A communication cable runs between helicopter 22 and control head 100 to transmit instructions from an operator to control head 100.

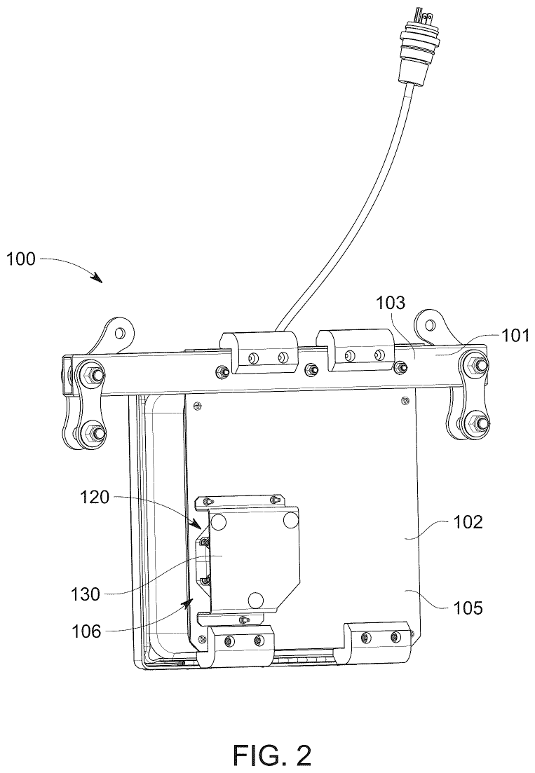

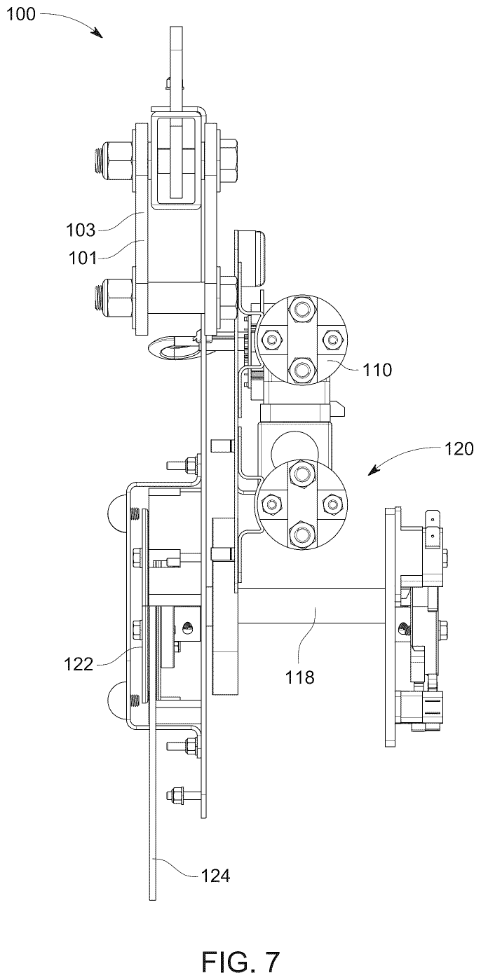

Referring to FIGS. 2-9, embodiments of the present invention include a control head 100 having a cable attachment member 103, a housing 102, an electronic head control system 104, and an actuator system 106.

Referring to FIG. 2, cable attachment member 103 is an elongate rigid spreader member 101. Elongate rigid spreader member 101 is an elongated spreader bar with opposite first and second ends, each of which includes a cable attachment point or portion for attaching bucket support cables 15 and control head support cables 17. Cable attachment member 103, shown as elongate rigid spreader member 101, is connected to housing 102 at a location approximately in the middle of spreader member 101 such that valve control line 124 leaves the pulley 122 at approximately the center of the spreader member 101 to balance the valve control line loads on the spreader member 101. As shown in the figures, cable attachment member 103, shown as spreader member 101, is connected to housing 102 with bolts, however spreader member 101 may be connected to housing 102 with any other suitable fastening means. As shown in FIG. 1, cable attachment member 103, shown as elongate rigid spreader member 101, is used to connect control head 100 to helicopter 22 and bucket 12.

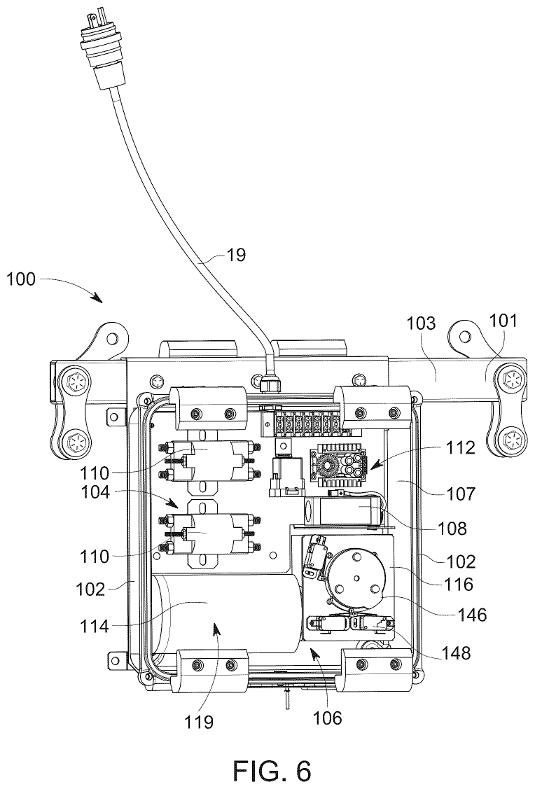

Housing 102 is preferably waterproof to protect the internal electronics and mechanisms from water and dust. For example, illustrated in FIG. 2 is a waterproof polyester box, which is a molded fibreglass enclosure with a matching hinged cover. Referring to FIG. 2 and FIG. 6, housing 102 has an exterior face 105 and interior face 107. Exterior face 105 is the face of housing 102 that faces the exterior of the enclosure that is housing 102. Interior face 107 is the face of housing 102 that faces the interior of the enclosure that is housing 102. Housing 102 acts as a protective box that encloses the inner workings of control head 100.

Referring to FIG. 6, electronic head control system 104 is housed inside housing 102 and includes a battery pack 108, power connectors 110, and related control circuitry 112. Electronic head control system 104 is for transmitting signals. Electronic head control system 104 is connected to a communication cable 19. An operator's control signals are transmitted through communication cable 19 to electronic head control system 104 to actuator system 106, which ultimately opens and closes valve 18. Electronic head control system 104 also serves to power actuator system 106.

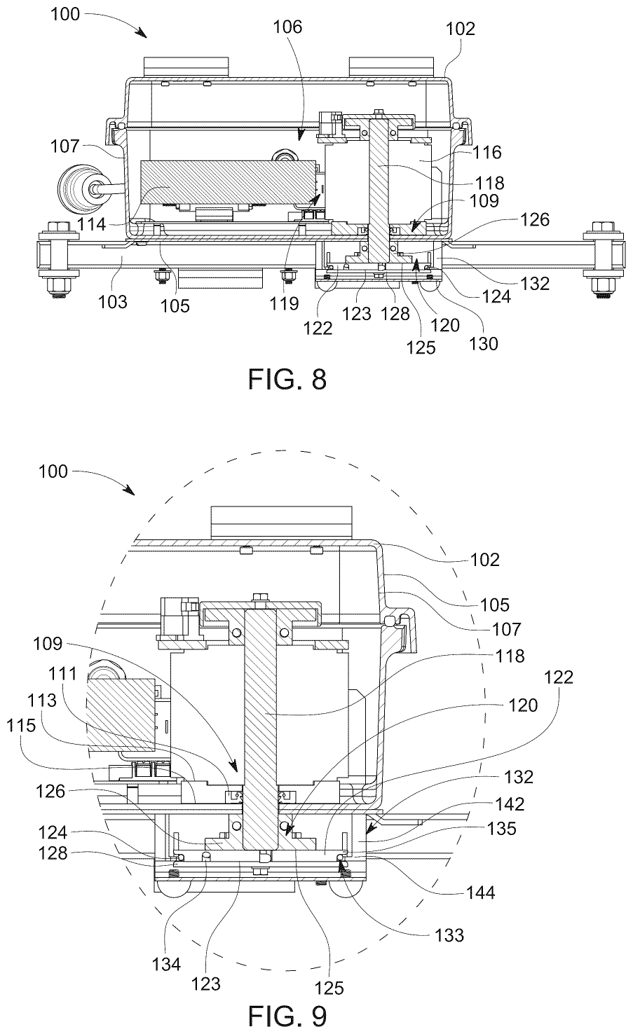

Referring to FIG. 6 and FIG. 8, actuator system 106 includes a driver system 119 and a drive pulley system 120. Driver system 119 includes a motor 114, a worm gear head 116, a drive shaft 118, cam surface 146, and limit switches 148. As shown in the figures, motor 114 is a DC electric motor, however, a person skilled in the art would understand that although a DC electric motor is preferred, many other suitable electronic motors may also be used. Driver system 119 is connected to electronic head control system 104 and drive pulley system 120 for driving drive pulley system 120. Motor 114 is connected to worm gear head 116, which together drives drive shaft 118. Drive shaft 118 extends from worm gear head 116 to drive pulley system 120.

Referring to FIG. 2, FIG. 8 and FIG. 9, drive pulley system 120 is located on exterior face 105 of housing 102 and includes a drive pulley 122, a valve control line 124, a shaft mount 126, a pulley cover 128, a pulley shield 130, and a pulley guard 132. The location of drive pulley system 120 being on exterior face 105 of housing 102 makes access much simpler and easier for servicing of drive pulley system 120.

Referring to FIG. 9, drive shaft 118 extends through a hole in the face of housing 102 and is connected to drive pulley system 120 by shaft mount 126. Various sealing mechanisms 109 are used to maintain the waterproof feature of housing 102 where drive shaft 118 extends through the face of housing 102. Such sealing mechanisms 109 include a rotary shaft seal 111, a seal plate 113, a silicone rubber gasket 115, and a commercially available NEMA™ 4X enclosure (which, as illustrated, is housing 102). Although such sealing mechanisms 109 have been chosen in this particular embodiment, a person skilled in the art would understand that various other sealing mechanisms may be suitably used to achieve an effective seal. Shaft mount 126 is a flange that is mounted on to drive shaft 118 and serves as a connector between drive shaft 118 and drive pulley 122. Drive pulley 122 is mounted on to shaft mount 126.

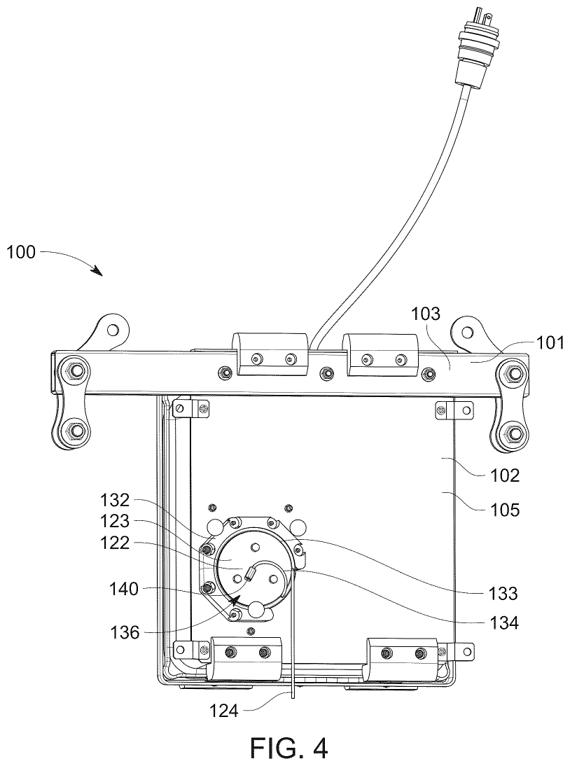

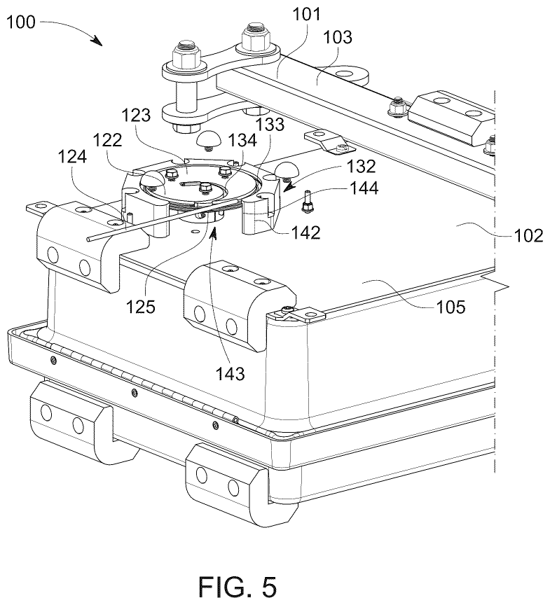

Referring to FIG. 4 and FIG. 5, drive pulley 122 has a first face 123 and a second face 125 and defines a channel 133 there between running along the circumference of drive pulley 122. There is a groove 134 on first face 123 of drive pulley 122. Valve control line 124 is removably inserted into groove 134 and channel 133 and valve control line 124 is retractable and extendable from drive pulley 122. Valve control line 124 wraps around drive pulley 122 in channel 133 and into groove 134. Groove 134 is designed as a gradual curve to reduce bending stress on the cable of valve control line 124, which is taut when loaded by valve 18. Valve control line 124 includes a first line end 136 and a second line end 138. At first line end 136 is an end piece 140, which is inserted into groove 134. End piece 140 is an enlarged cable end stop that serves to secure valve control line 124 in drive pulley 122 and prevents any back slipping of valve control line 124. Second line end 138 is attached to valve 18 (as shown in FIG. 1). Groove 134 is configured to fit and hold valve control line 124 including end piece 140. Channel 133 may include one or more channel walls 135. Referring to FIG. 9, channel 133 has one channel wall 135 while pulley cover 128 forms a second channel wall 135. Referring to FIG. 8, motor 114, worm gear head 116, drive shaft 118 and drive pulley 122 work together to convert the electronic control signal from the operator into the mechanical action of retracting and extending valve control line 124 to open and close valve 18.

Referring to FIG. 4, FIG. 5 and FIG. 9, pulley guard 132 includes one or more walls 142 projecting from exterior face 105 of housing 102 and includes a flange 144 on the distal end. Walls 142 can be made of multiple contiguous sections for ease of construction and assembly or can be made of one continuous piece. Walls 142 are mounted onto exterior face 105 of housing 102 with bolts or other suitable fastening means. Walls 142 are proportioned and configured to surround drive pulley 122 in close proximity and shields drive pulley 122 and valve control line 124 from interference from objects in the external environment. Walls 142 include a gap 143 that is a break in the continuity of walls 142 and that allows for valve control line 124 to pass through. Flange 144 projects inwardly from walls 142 and is proportioned and configured to fit within channel 133 in a manner where the sides of channel 133 cooperates with flange 144 in order to prevent valve control line 124 from being displaced out of channel 133. That is, flange 144 of pulley guard 132 cooperates with channel 133 and operates to maintain valve control line 124 within channel 133.

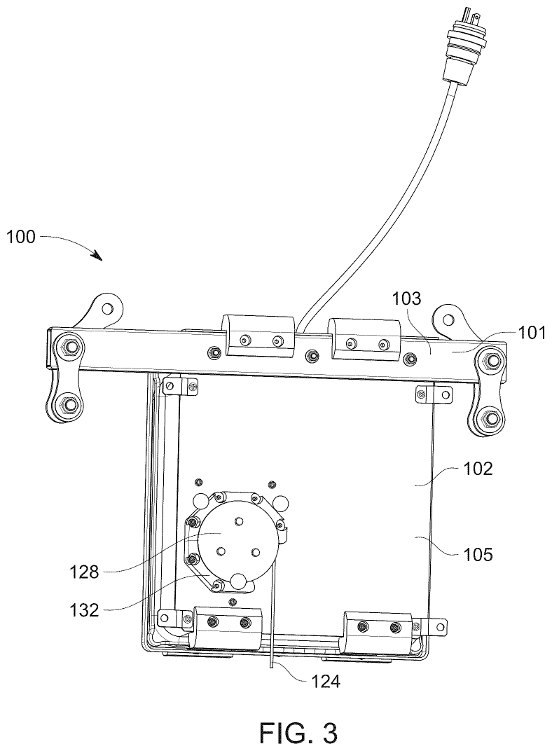

Referring to FIG. 3 and FIG. 8, pulley cover 128 is removably mounted to first face 123 of drive pulley 122. Pulley cover 128 covers the face of drive pulley 122 and conceals groove 134 and channel 133. Referring to FIG. 3 and FIG. 4, pulley cover 128 also assists with securing end piece 140 and valve control line 124 within groove 134. Pulley cover 128 is mounted on to the face of drive pulley 122 with bolts or other suitable fastening means.

Referring to FIG. 2, pulley shield 130 is removably mounted to exterior face 105 of the housing 102 and is configured to shield drive pulley system 120. Pulley shield 130 is a U-shaped plate that covers drive pulley system 120 and shields drive pulley system 120 from interference and damage from objects in the external environment. Pulley shield 130 may be fabricated with the same materials as housing 102 or any other suitable materials. Although a U-shaped plate has been chosen in this particular embodiment, a person skilled in the art would understand that various other shapes may be suitably used to achieve an effective protective cover.

Referring to FIG. 6, the extent of rotation of drive pulley 122 is controlled by cam surface 146 actuating limit switches 148 that are coupled to motor 114. Cam surface 146 is connected to drive shaft 118. Limit switches 148 are disposed in a position relative to cam surface 146 to enable cam surface to actuate limit switches 148. Cam surface 146 is configured to actuate limit switches 148 to limit the extent of rotation of drive pulley 122. When cam surface 146 actuates one of limit switches 148, drive pulley 122 is effectively at an end stop of rotation in which valve control line 124 is extended to close valve 18, and when cam surface 146 actuates the other of limit switches 148, drive pulley 122 is effectively at an opposite end stop of rotation in which valve control line 124 is retracted to open valve 18. Hence, the range of rotation of drive pulley 122, and the extension and retraction of valve control line 124, is determined when cam surface 146 contacts one or the other of limit switches 148.

An advantage of the above configuration lies in the location of actuator system 106 being on the exterior of housing 102. This external location of actuator system 106 allows for easy access for maintenance or replacement. This is further made simpler by the ease with which pulley shield 130 may be removed and attached.

Another advantage of the above configuration is that valve control line 124 can be quickly and easily replaced by removing pulley cover 128 and simply pulling out the old valve control line 124 from groove 134 and inserting in a new valve control line 124 into groove 134. The location of groove 134 and end piece 140 being on the face of drive pulley 122 allows for quick and easy access as well as use of a narrower drive pulley 122. Use of a narrower drive pulley 122 enables a thinner profile overall for control head 100.

It is understood that the embodiments described and illustrated herein are merely illustrative of embodiments of the present invention. Other embodiments that would occur to those skilled in the art are contemplated within the scope of the present invention. The invention includes variants not described or illustrated herein in detail. Thus, the scope of the claims should not be limited by the embodiments described and illustrated herein but should be given the broadest interpretation consistent with the description as a whole.

What is claimed is:

1. A suspension and control head apparatus for an aerial firefighting bucket, the suspension and control head apparatus comprising:
a cable attachment member;
a housing connected to the cable attachment member, the housing having an exterior face and an interior face;
an electronic head control system contained in the housing, the electronic head control system for transmitting signals;
a drive pulley system mounted to the exterior face of the housing, the drive pulley system comprising:
a valve control line with a first end and a second end;
an end piece on the first end;
a drive pulley with a first face and a second face defining a channel there between running along the circumference of the drive pulley;
a groove on the first face of the drive pulley configured to fit the end piece of the valve control line; and
a driver system connected to the electronic head control system and the drive pulley system, the driver system for driving the drive pulley system;
wherein the valve control line is removably inserted into the groove and the channel and the valve control line is retractable and extendable from the drive pulley.

2. The suspension and control head apparatus of claim 1, wherein the drive pulley system further comprises a pulley cover removably mounted to the first face of the drive pulley.

3. The suspension and control head apparatus of claim 1, wherein the drive pulley system further comprises a pulley guard extending from the exterior face of the housing and configured to fit within the channel of the drive pulley, the pulley guard cooperating with the channel to maintain the valve control line within the channel.

4. The suspension and control head apparatus of claim 1 further comprising a pulley shield removably mounted to the exterior face of the housing and configured to shield the drive pulley system.

5. The suspension and control head apparatus of claim 1, wherein the driver system further comprises:
a motor;
a drive shaft connected to the motor, the motor driving the drive shaft;
a cam surface connected to the drive shaft; and
limit switches disposed in a position relative to the cam surface to enable the cam surface to actuate the limit switches;
wherein the cam surface is configured to actuate the limit switches to limit the extent of rotation of the drive pulley.

6. The suspension and control head apparatus of claim 1, wherein the end piece is an enlarged cable end stop.
